(19) United States
(12) Patent Application Publication
(10) Pub. No.: US 2015/0261769 A1
(43) Pub. Date: Sep. 17, 2015

(54) Local Safety Network

(71) Applicants: Joanne Uta Ono, San Jose, CA (US); Jack Tungcheih Lee, Bellevue, WA (US)

(72) Inventors: Joanne Uta Ono, San Jose, CA (US); Jack Tungcheih Lee, Bellevue, WA (US)

(21) Appl. No.: 14/214,620

(22) Filed: Mar. 14, 2014

(51) Int. Cl. G06F 17/30

(52) U.S. Cl. CPC G06F 17/3087; G06F 17/30952; G06F 17/3053

(57) ABSTRACT

Provided are system, devices and methods for initiating and executing a response to an event, in particular an adverse event. Embodiments of the invention allow a user to use a mobile electronic communication device, such as a smart phone, to access communication channels to generate a list of contactable entities relevant to the event, prioritized by considerations like proximity, appropriateness for the type of event, and appropriateness for the risk level of the event. Additionally, embodiments of the invention may allow for aspects of the management of a response to the event, for instance by enabling a network of responders, created based on the prioritized list of contactable entities.

### BACKGROUND

The rapidly increasing communication abilities of mobile devices are enabling better and more rapid notification and management of adverse events like medical emergencies, criminal activity or natural disasters. Communication and event management networks involving users experiencing an event and responders responding to the event are known in the art. Until now, these networks are often based on existing networks or contact lists, and are not real-time generated and updated based on the full search and communication ability of mobile technology.

US Patent Application 20130222133 (Schultz, P T, et al.) discloses an approach for enabling event notifications to be directed to one or more contacts based on the acquiring of common event data by one or more wireless devices. A multimedia event processor receives event data corresponding to an event from a mobile device. The event data is associated with a tag for describing the event data and classified as corresponding to a level of severity based on the tag. A target destination is then determined for transmission of a notification message, the event data, or a combination thereof. Parties to be notified are selected from a user-designated group. Severity is represented by a tag, wherein the tag is associated with the event based on a match between the observed event and a predetermined type of event selected from a group of predetermined types of events.

Schultz does not disclose an independent search capability of the device for relevant locally available contactable entities, nor a capability of generating a prioritized list of contactable entities, wherein the priority is based on the nature of the event. Schultz also does not disclose an intelligent capability to search Internet-based sources for information relevant to the event, based on information data received from the event.

US Patent Application 20130052982 (Rohde, G L, et al.) discloses a mobile application for execution on a handheld computing device that stores data regarding connections to public safety answering points with which to share information in an emergency situation and establishes connections with an appropriate public safety answering point upon activation of an emergency button, wherein the connections include voice, text, image and video connections. A user is able to create a list of contacts for a private social emergency response network with which to send previously stored private information in an emergency. In an emergency, the mobile application establishes a platform via which the user and those on the private social emergency response network can share information. The mobile application also sends previously stored private information to those on the list during an emergency.

Rohde does not disclose a capability to search local communication channels for entities to contact in case of an event, where the entities may not be known to a user of the device, or have not been entered previously by the user into the device. Rohde also does not disclose a capability to prioritize the order in which to contact the contactable entities, based on the nature of the event.

U.S. Pat. No. 8,493,208 (Aaron, J.) discloses a wireless communication device and a communication device control method that include a set of templates corresponding to a plurality of potential environmental circumstances. The templates may be stored in a database in the computer readable memory of the communication device. At predetermined intervals, a suite of environmental sensors integral to the communication device may periodically sample the user's environment. The user's environmental circumstances may be derived or inferred by an analysis module based on the output of the suite of environmental sensors and then may be compared to the templates to determine a matching template. An action script is then executed based at least partially on the matching template, which may include the contacting of a responding party.

Aaron does not disclose generating a prioritized list of contactable entities, wherein the priority is based on the nature of the event. Aaron also does not disclose an intelligent capability to search Internet-based sources for information relevant to the event.

U.S. Pat. No. 8,630,820 (Amis, D.) discloses methods and systems anticipating a potentially threatening or dangerous incident, and providing varying levels of response to a user. In an exemplary embodiment, the present invention provides varying levels of assistance to a user prior to, during, and after a threatening incident occurs. By providing assistance prior to a threatening incident occurring, the system may be able to thwart potential attacks, bodily harm, robberies, break-ins, and other criminal or dangerous activity. The assistance can be, for example, in the form of deterrents, alerting first responders to go to the scene, sending security personnel to the scene, remotely monitoring the scene, remotely interacting with the scene, providing information and advice to the user.

Amis does not disclose generating a prioritized list of contactable entities, wherein the priority is based on the nature of the event. Amis also does not disclose an intelligent capability to search Internet-based sources for information relevant to the event.

US Patent Application 20100158202 (Johnson, R S. Et al.) discloses a method for dispatching emergency responders. The method identifies emergency responders proximate an emergency incident site. Of these emergency responders, qualified emergency responders are identified, wherein qualified emergency responders have sufficient resources to service an emergency incident at the emergency incident site. The method identifies travel obstructions between the qualified emergency responders and the emergency incident site. Travel times between each of the qualified emergency responders and the emergency incident site are determined based on the travel obstructions. A first emergency responder is selected from the qualified emergency responders, wherein the first emergency responder has a first travel time that is the shortest travel time of the determined travel times. One or more standby emergency responders are also selected, wherein the standby emergency responders have a second travel time that is the next shortest travel time of the determined travel times.

Johnson does not include stationary entities to which a user of a device might travel, or responders where contact may be entirely electronic, requiring no physical travel, like a remote personal physician with knowledge about specific medical conditions of a user. Johnson does not disclose a capability of changing the priority based on real time assessments of developments in the location of the event.

None of the prior art identified discloses means for exploring locally available communication channels for relevant contactable entities based on information data received with respect to an event and generating a prioritized list of contactable entities, based on the information data. None of the prior art identified discloses an intelligent capability to actively search Internet-based sources for information relevant to the event based on information data, such as keywords or images, received with respect to an event. None of the prior art identified discloses a capability for changing priorities on the contact list based on real time assessments of developments with respect to the event.

Consequently, there is a need for an event response system, capable of functions such as receiving information data from an event, identifying locally available contactable entities relevant to the event, exploring available communication channels for additional information relevant to the event, generating a list of contactable entities, prioritized by relevance to the event, contacting entities on the list, monitoring developments at the event, or updating the priorities on the list of contactable entities based on the developments.

### SUMMARY

Generally, the invention provides devices, systems and methods for facilitating and initiating a response to an event experienced by a user. In some embodiments the devices include a wearable or portable device. In some cases, the event may be an adverse event, such as a medical emergency, equipment failure, accident or criminal activity.

Embodiments of the invention include, but are not limited to:

A method for managing communications with respect to an event, comprising the steps of
determining a location of the event,
providing information about a nature of the event,
using locally available electronic communication channels for identifying a number of contactable entities,
determining locations and nature of contactable entities,
determining proximities between contactable entities and the event,
determining appropriateness of contactable entities to the nature of the event,
providing a list of contactable entities, prioritized by proximity to the event and by appropriateness to the nature of the event.

The method of Paragraph 00015, further comprising the step of providing a limitation criterion for the number of contactable entities.

The method of Paragraph 00015, wherein the limitation criterion is based on proximity

The method of Paragraph 00015, wherein the limitation criterion is a pre-defined maximum for the number of contactable entities.

The method of Paragraph 00015, wherein the appropriateness of contactable entities is based on a keyword match between the information about the nature of the event and the nature of the contactable entity.

The method of Paragraph 00015, further comprising the steps of
accessing an information database with previously entered contactable entities,
determining proximities between contactable entities in the database and the event, and
determining appropriateness of contactable entities in the database to the nature of the event.

The method of Paragraph 00015, further comprising the steps of
performing an Internet-based search based on location of the event and information about the nature of the event, and
using results of the Internet-based search in prioritizing contactable entities.

The method of Paragraph 00015, further comprising the steps of
performing a risk analysis and
using results of the risk analysis in prioritizing contactable entities.

The method of Paragraph 00015, further comprising the steps of
monitoring developments with respect to the event, and
updating the list of contactable entities, prioritized by proximity to the event and by appropriateness to the nature of the event, based on the developments with respect to the event.

A non-transitory computer readable medium having instructions recorded thereon which, when executed by a processor, cause the processor to perform a method for managing communications with respect to an event, comprising the steps of
determining a location of the event,
providing information about a nature of the event,
using locally available electronic communication channels for identifying a number of contactable entities,
determining locations and nature of contactable entities,
determining proximities between contactable entities and the event,
determining appropriateness of contactable entities to the nature of the event,
providing a list of contactable entities, prioritized by proximity to the event and by appropriateness to the nature of the event.

The non-transitory computer readable medium of Paragraph 00024, wherein the method further comprises the step of providing a limitation criterion for the number of contactable entities.

The non-transitory computer readable medium of Paragraph 00024, wherein the limitation criterion is based on proximity.

The non-transitory computer readable medium of Paragraph 00024, wherein the limitation criterion is a pre-defined maximum for the number of contactable entities.

The non-transitory computer readable medium of Paragraph 00024, wherein the appropriateness of contactable entities is based on a keyword match between the information about the nature of the event and the nature of the contactable entity.

The non-transitory computer readable medium of Paragraph 00024, wherein the method further comprises the steps of
accessing an information database with previously entered contactable entities,
determining proximities between contactable entities in the database and the event, and
determining appropriateness of contactable entities in the database to the nature of the event.

The non-transitory computer readable medium of Paragraph 00024, wherein the method further comprises the steps of the steps of
performing an Internet-based search based on location of the event and information about the nature of the event, and
using results of the Internet-based search in prioritizing contactable entities.

The non-transitory computer readable medium of Paragraph 00024, wherein the method further comprises the steps of the steps of
performing a risk analysis and
using results of the risk analysis in prioritizing contactable entities.

The non-transitory computer readable medium of Paragraph 00024, wherein the method further comprises the steps of
monitoring developments with respect to the event, and
updating the list of contactable entities, prioritized by proximity to the event and by appropriateness to the nature of the event, based on the developments with respect to the event.

A system for managing communications with respect to an event, comprising
a mobile electronic communication device,
a location determination capability
an electronic search capability for contactable entities
a user input interface
a keyword matching capability
a proximity calculation capability
a sorting algorithm based on proximity and keyword match
an output interface, and, optionally
an information database with previously entered contactable entities and, optionally, an Internet-based search capability,
wherein the algorithm comprises instructions for receiving input from
the location determination capability,
the electronic search capability for contactable entities,
the user input interface,
the keyword matching capability,
the proximity calculation capability, and, optionally,
the information database with previously entered contactable entities and, optionally,
the Internet-based search capability, and wherein
the algorithm comprises instructions for providing output to the output interface comprising a list of contactable entities, prioritized by proximity to the event and by appropriateness to the nature of the event.

The system of paragraph 0033, further comprising
1. a capability to monitor developments with respect to the event, and wherein
2. the algorithm comprises instructions for receiving input the capability to monitor developments with respect to the event, and wherein
3. the algorithm comprises instructions for providing output comprising updates to the list of contactable entities, prioritized by proximity to the event and by appropriateness to the nature of the event, based on the developments with respect to the event.

### BRIEF DESCRIPTION OF THE DRAWINGS

FIG. 1A illustrates an exemplary embodiment of a flow of activities according to the invention.

FIG. 1B illustrates an exemplary embodiment of a flow of activities according to the invention.

FIG. 2A illustrates an exemplary embodiment of a flow of activities according to the invention pertaining to a high-risk event.

FIG. 2B illustrates an exemplary embodiment of a flow of activities according to the invention pertaining to a low-risk event.

FIG. 3A illustrates exemplary embodiments of device search capabilities and identified contacts as an input to a flow of activities according to the invention.

FIG. 3B illustrates exemplary embodiments of event input and input methods for a flow of activities according to the invention.

FIG. 3C illustrates an exemplary embodiments of a flow of activities according to the invention, with inputs as illustrated in FIGS. 3A and 3B.

FIG. 4 illustrates an output of a risk assessment according to the invention.

FIG. 5 illustrates a detailed flow of a generation of a prioritized contact list according to the invention.

FIG. 6 illustrates a detailed flow of a generation of a prioritized contact list according to the invention.

FIG. 7 illustrates a detailed flow of a generation of a prioritized contact list according to the invention.

FIG. 8 illustrates a detailed flow of a generation of a prioritized contact list according to the invention.

FIG. 9 illustrates a communication network generated according to methods of the invention.

FIG. 10 illustrates a communication network generated according to methods of the invention.

### DETAILED DESCRIPTION

It is an objective of the invention to provide devices, systems and methods for facilitating and initiating a response to an event experienced by a user. In some embodiments the devices include a wearable or portable device. In some cases, the event may be an adverse event, such as a medical emergency, equipment failure, accident or criminal activity. Throughout this disclosure the term “include” shall mean “include, but not limited to”.

Functions of embodiments of the invention may include generating, in real time and upon activation, a prioritized list of contactable entities, the entities being selected from a number of contactable entities previously entered into the device, and/or a list of locally available contactable entities identified by the device upon activation at a location. The term contactable entities refers to entities where an attempt to contact may be made. It does not imply that attempts to contact are actually made or are successful.

Criteria for the prioritization may include nature of the event, such as medical, technical or criminal events, nature of contactable entities, such as emergency responders, physicians, pharmacies or law enforcement, and additional information such as proximity between a contactable entity and an event, preferences previously entered by the user, etc. Proximity between a contactable entity and an event may be expressed in a variety of ways, including distance and travel time.

In some embodiments a device may have a capability to assess the level of appropriateness of a contactable entity for the event. The appropriateness may be based on a match between the nature of the event and the nature of the contactable entity, and may assessed based on a match of keywords used to describe the event and the contactable entity. In some embodiments the device prioritizes appropriateness over proximity; in some embodiments the device prioritizes proximity over appropriateness; and in some embodiments the device sorts by a hybrid of proximity and appropriateness. In some embodiments the sorting criteria are default criteria by the manufacturer; in some embodiments the sorting criteria are custom settings by a user of the device.

Further functions of embodiments of the invention may include accessing locally available communication systems for available information, such as Internet-based information, relevant to the event and incorporating the information in the determination of the priority of contactable entities on the contact list.

Some embodiments of the invention may be able to perform a risk analysis associated with the event, and incorporate results of the risk analysis in the prioritization of the contactable entities.

Further functions of embodiments of the invention may include contacting or attempting to contact identified contactable entities in order of priority.

Further functions of embodiments of the invention may include assessing a response from contacted entities, terminating contacting or attempting to contact contactable entities when a response has been assessed to be adequate, and providing communication means and channels between entities involved in a response.

Further functions of embodiments of the invention may include monitoring developments with respect to the event, and updating the priority of contactable entities on the contact list based on the developments.

Further functions of the devices, systems and methods may include initiating defensive measures, such as sounding alarms, activating deterrents like releasing chemicals, spraying ink or releasing other traceable compounds, automatically analyzing and/or creating video and audio recordings of the event, its aftermath and ensuing response, warning users of environmental hazards, measuring vital signs of a user, and/or alerting user of possible appropriate resources nearby.

In some cases the user may be a human. In some cases the human may be an impaired person or a child. In some cases a device may be worn by an animal or paired with an inanimate object, like a piece of jewelry or important document

In those cases where the entity wearing or being paired with a device is not the entity entering data or instructions into the device, the term “user” may refer to both the entity wearing or being paired with the device, as well as the entity entering data or instructions into the device.

In some embodiments activation and functions of a device may be controlled by the device in an automatic mode, in some embodiments the response may be controlled by a user, and in some embodiments control of the response may be a hybrid of user and device analysis and/or actions. For instance, a user may verbalize their location to be home but the GPS determines they are not and override the user, or a voice analysis shows stress in the user and this may trigger a notification of an event. In some embodiments control of the device may be taken over by a remote responder after initiation of the response and/or the control of the device will be passed from one entity to another, as the situation develops.

In some embodiments, systems according to the invention may be capable of initiating an entire cascade of communications, responses and user-feedback based on a single touch activation input These embodiments of the invention may be especially useful in cases where the window of opportunity to initiate a response by a user may be limited, for instance in cases of a fall, impending incapacitation like a stroke, criminal attack and the like.

The system may also be capable of initiating such a cascade autonomically, for instance based on an observation of a pre-determined bodily function event or when a user approaches or passes a predetermined geographical position. Examples would be a detection of low blood sugar in a diabetic, or the straying of a child outside a parental home, or recreational facility/park.

In this disclosure the term contactable entity may include any entity a user may want to contact in relation to an event. The term responder may include any entity responding to an event or an alert to an event. Typically, a responder may be a contactable entity, like a, Emergency Medical Technician (EMT) or police officer.

Contactable entities may include responders, as well as non-responders. For instance, a contactable entity may be a nearby pharmacy, to which a patient may be directed, where the pharmacy may not be alerted to an event, and, consequently, does not take any action to respond.

In some embodiments a device is capable of determining a location of the event and the user, and the response may in part be based on the location. Determination of a location may be performed based on a variety of methods, such as GPS, cell phone tower vicinity, WIFI vicinity, geographical triangulation, etc.

In some embodiments, all capabilities to perform functions of a device are located on the device, or on a companion device carried by the user. In some embodiments locally performed functions, such as location determination and audio/video recording of the event and its aftermath and the ensuing response may be located on a device worn by a user, but other functions, such as hazard assessment, coordination of emergency response and conferencing of various responders may be located on a remote equipment, such as server, computer or other piece of hardware, and the device worn by a user may function as a communication means.

In some embodiments the system may comprise or have access to language recognition and translation capabilities. In some embodiments the system may be able to recognize local language requirements and have a capability of translating between a user and a locally contacted entity. Recognition of language requirements may be based in information including GPS readings and contacts made with locally contactable entities, radio stations, etc.

For the purpose of this disclosure, the term device is used in a sense that includes embodiments in which a single device worn by or paired with a user performs the functions of the invention, as well as embodiments in which a plurality of devices, including at least one device worn by or paired with a user perform, in combination, the functions of the invention.

In some embodiments of the invention, the communication between the communication device and the responders may be routed through an existing network of communication channels like social networks, tele-communications networks, and e-mail accounts.

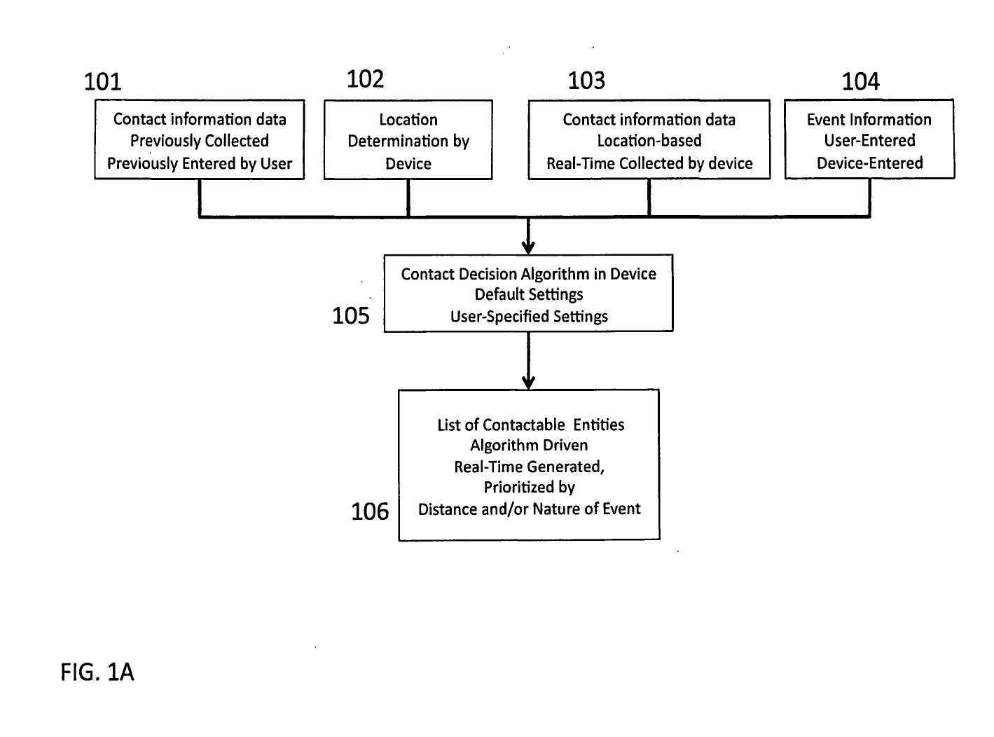

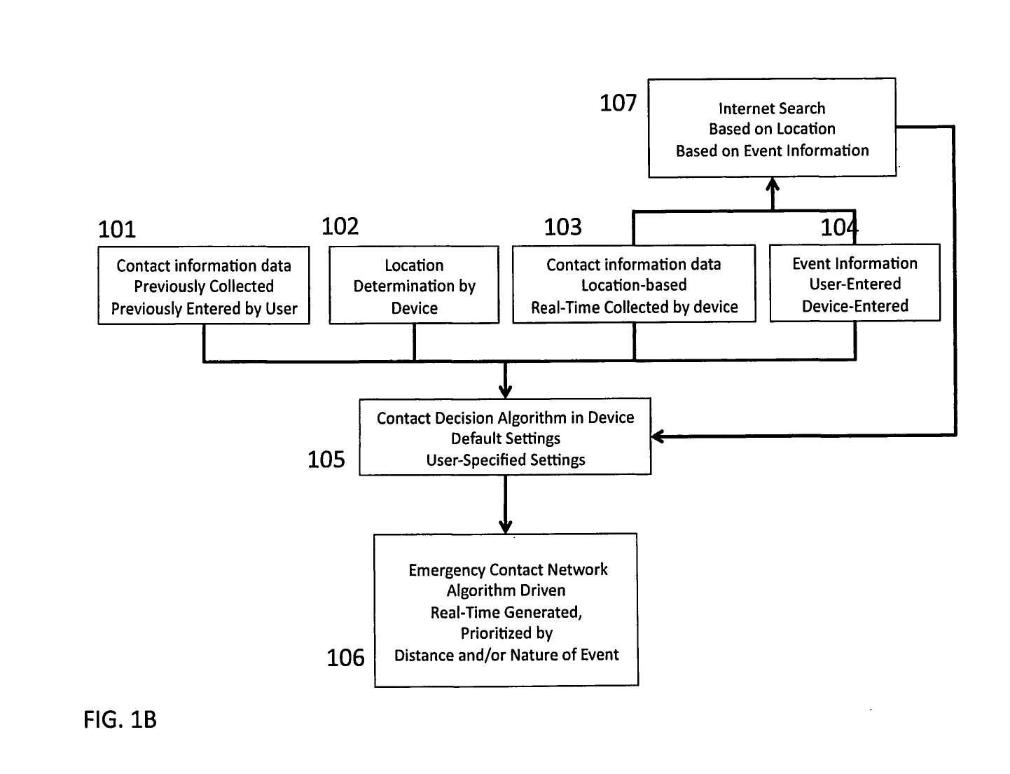

FIG. 1A illustrates a high level overview of an exemplary embodiment of an architecture of methods according to the invention.

In Step 101 information pertaining to a user of a portable or wearable device is entered. In preferred embodiments, the information in Step 101 is entered into the device prior to activation of the device in response to an event. This information may include any type of contact information, including a variety of categories of contacts, such as friends and family, medical professionals, professional associates and colleagues, and social network connections. The information may include additional data such as medical records, allergies, religious beliefs, and other data of potential interest in case of events such an emergency situations or other events requiring assistance. The data may be entered by any suitable means, including by hand, downloaded from phone records or other database, and by selection from connections on a social network. In preferred embodiments the contact information includes geographical location information. In the case of phone records, the system employed by the user may be able to assign location information based on area codes. The user may further include contact information for public entities, such as emergency numbers like 911 and other public entities the user may deem desirable, and location information about such public entities.

In step 102 the device determines its location upon activation. Determination of a location may be performed based on a variety of methods, such as GPS, cell phone tower vicinity, WIFI vicinity, geographical triangulation such as LORAN, etc.

Activation of the device may be performed in a variety of ways, including user-controlled means, such as a simple 1-touch “panic button”, multiple touch buttons, alphanumeric means such as keyboards, touch screens, and voice control including full Voice Recognition/Natural Language Processing capability, and automatic or semi-automatic modes including, the use of sensors for indicators for vital signs such as body temperature, heart rate, blood glucose, blood pressure and other signs or symptoms of physiological events.

Other sensors may include accelerometers (For instance to measure a fall or collision) and thermometers (For instance measuring adverse weather conditions), or location sensors, such as GPS (For instance to alert a user of a potentially hazardous location).

In Step 103 the device collects local contact information after being activated in response to an event and after determining its location. The device may be any type of device capable of using the communication channels, such as cell phones, cell-phone plug-in devices, dedicated communication devices, hand-held radios and walkie-talkies. In some embodiments the device may be a communication device in contact with a remote computer, for instance a user's home computer system. In the latter case, functional aspects of the invention may be performed by the remote computer, with the portable device being the pass-through communication device. The information may be collected from any available communication channel, including cellular networks, WIFI systems, wired systems phone lines, radio systems like HAM or CB etc.

The information collected may pertain to any number of locally available resources, including public or private entities, responder organizations, information systems and networks and individual entities.

In step 104 information about the event is collected. Data collection may be performed in a variety of ways, including user-controlled means, such as a simple touch buttons, keyboard, touch screen, and voice control including full Voice Recognition/Natural Language Processing capability. In some embodiments the user may employ recording capabilities on the device, such as audio and video capability to collect the information.

Automatic or semi-automatic data collection modes may include the use of the audio and video capabilities as well, and may further include the use of sensors, such as thermometers, seismometers, anemometers, hygrometers, rain meters etc. to detect possible natural disasters, and sensors for indicators such as body temperature, heart rate, blood glucose, blood pressure and other signs or symptoms of adverse physiological events.

In step 105 an algorithm collects and processes information input from the previous steps to generate an output in the form of a prioritized list of entities to be contacted in response to the event. The algorithm may use any or all of the information sources described above.

For instance, if the event occurs at a home location of a user, the algorithm may access exclusively information collected in step 101.
In some embodiments step 104 may be absent, and the list of entities to be contacted may be based on location information only.
In some embodiments the list of entities to be contacted is generated and prioritized based on location information, as well as on information specific to the event, as collected in Step 104.
In some embodiments the algorithm is based on default settings for instructions for processing the input information. For instance, factory-entered settings may be based on generic steps for the generation of a list of entities to be contacted, and on a number of statistical evaluations of outcomes to response implementations in historical event scenarios similar to the events entered in a current case. In some embodiments location specific information may in part determine the instructions in the algorithm.

In some embodiments a user of the device has an option to specify or customize the instructions in the algorithm to a personal preference.

In some embodiments the device has a machine learning capability, and may update the instructions in the algorithm based on information collected by the device during use or active stand-by periods, in which the device is capable of collection information through available information channels.

Since the reach of mobile electronic communication devices may be global, it is technically possible to identify very large numbers of contactable entities. For practical purposes, preferred embodiments may have a limitation criterion for the number of contactable entities to be identified.

Limitation criteria may be based on such parameters as acceptable proximity, as disclosed in more detail further below, for instance “all within 1 mile”, “all within 5 miles”, all within 15 minutes, etc. Alternatively, no proximity limits may be set, but the device may be instructed to search for the nearest defined number of contactable entities, such as the nearest 5 or 10 contactable entities.
The number of contactable entities may be defined by default factory settings, or may be defined by settings customized by a user of the device.
In some instances, for instance in extreme distress or danger, a user may choose to have all entities in a previously entered data base be placed on the contact list.

In step 106 the output of the algorithm in the form of a list of contactable entities is generated. In preferred embodiments the list is a prioritized list, wherein the priority of the contacts is based on both the proximity of the contactable entities to the event, and the appropriateness of the contactable entities to the event.

In some preferred embodiments the device is capable of initiating and executing attempts to contact the contactable entities in order of priority.

As illustrated in FIG. 1B, step 107 may be added, in which the device performs an Internet search based on information including information with respect to the location and the nature of the event. Information about the location of the event may come from various sources, including electronic data, such as a GPS, or from manually entered data from a user. Information about the event may include keywords for a search, such as “fire” and a date and time of year, which may trigger a search for a risk of forest fires at that location, time of year and local weather. Such information may prioritize notification of a fire department and an office of the National Forest Service.

Embodiments of the invention may operate based on different levels of information available or being used. It should be understood that the information in boxes 101, 102, 103, 104 and 107 can be collected and used independently of each other. For instance, in some embodiments only information of Box 101 and 102 may be used, in some embodiments, only information from box 102, 103 and 104 may be used, etc. This is illustrated in more detail in following exemplary, non-limiting embodiments.

### Level 1

Only information of Box 101 and Box 102 is entered into the sorting algorithm.

An exemplary embodiment according to the invention comprises
a database with contact information for contactable entities, including location information, entered by or on behalf of a user,
a location determination capability,
a contact decision algorithm including:
   a. a capability to determine proximity between an event and contactable entities, and
   b. a sorting capability based on proximity.

### Activation of the Device Triggers

a contact information input into the algorithm,
a determination of the location, and
a location input to the algorithm.
   The algorithm sorts the contact information proximity, and produces a list of contactable entities prioritized by proximity between the entities and the event.

In some embodiments the device may be capable of assessing travel time, like drive time, rather than distance, and a contact list may be prioritized by transportation time rather than distance. For instance, an emergency clinic 7 miles away on a freeway may be reachable faster than an emergency clinic 5 miles away across an urban area.

In some embodiments, the device may be able to take current traffic situations into consideration when calculating transportation times.
In yet alternative situations a device may be instructed to search for contactable entities within a defined range of transportation times and prioritize the list accordingly.

### Example 1

A user is driving to a family member when his car breaks down in the city of destination. He is not familiar with the city, but the family member has provided him with a number of reliable car shops and towing services, which he has entered into his portable device. The user enters a request for a towing service, and the device produces a list of towing services from the pre-entered database, based on travel time to the breakdown.

### Level 2

Information of Box 101, Box 102 and Box 103 is entered into the sorting algorithm.

An exemplary embodiment according to the invention comprises
a database with contact information for contactable entities, including location information, entered by or on behalf of a user,
a location determination capability,
a search capability for locally available contactable entities,
a contact decision algorithm including:
   a. a capability to determine proximity between an event and contactable entities, and
   b. a sorting capability based on proximity.

### Activation of the Device Triggers

a contact information input into the algorithm,
a determination of the location,
a location input to the algorithm,
generation of contact information for locally available contactable entities, including location information by the search capability of the device, and
an input of contact information for locally available contactable entities into the algorithm.
   The algorithm sorts the contact information entered by or on behalf of the user and the contact information entered by the search capability of the device, and produces a list of contactable entities prioritized by proximity between the entities and the event.
   In some embodiments the algorithm may generate a prioritized contact list based on an additional set of specific instructions. For example, in some embodiments, the algorithm may be programmed to prioritize locally available public responders over private entities, before prioritizing by proximity.

It should be emphasized that the contactable entities according to the invention are not limited to emergency responders travelling to the event, but include all entities that a user may wish to contact or to be notified, including entities to which a user would travel, like a nearby pharmacy, emergency clinic, family member etc.

Also included may be entities where contact would not have involved any travel, but a communication by electronic means like a phone call text message etc. such as a communication to a personal physician or family member. For instance, an algorithm could include information and/or an instruction to call a personal physician in any medical event, independent of distance.

### Example 2

A user with occasional angina pectoris episodes drives in a suburban neighborhood and experiences upcoming chest pain. She realizes she has forgotten her medication. The user activates the device and enters a request for urgent prescription drug supply. In some embodiments the device may determine a location, and identify a number of nearby pharmacies, sorted by travel time by car. The device may also produce contact information for a personal physician, and, as a backup, an address for a nearby emergency clinic. In some embodiments the device may contact the pharmacies in order of drive time. In some embodiments the device may provide a number of a personal physician to a contacted pharmacy

### Level 3

Information of Box 102, Box 103 and Box 104 is entered into the sorting algorithm.

An exemplary embodiment according to the invention comprises
a location determination capability,
a search capability for information about locally available contactable entities, including information about location and nature of the contactable entity,
a capability to collect data with respect to the nature of the event,
a keyword recognition capability to match the nature of the event to the nature of the contactable entity and determine the appropriateness of the contactable entity for the event.
a contact decision algorithm including:
   a. a capability to determine proximity between an event and contactable entities,
   b. a capability to assess the nature of the event, and
   c. a sorting capability based on proximity and on appropriateness of contactable entities for the nature of the event.
      Activation of the device triggers
a determination of the location,
a determination of the current time,
a location input to the algorithm,
generation of information for locally available contactable entities including information about location and nature by the search capability of the device,
a keyword matching sequence to determine the appropriateness of the contactable entity,
an input of information for locally available contactable entities into the algorithm
data collection to assess the nature of the event, and
an input of data with respect to the nature of the device into the algorithm.
   The algorithm sorts the contactable entities entered by the search capability of the device by proximity to the event and by appropriateness for the nature of the event, and produces a list of contactable entities prioritized by proximity and by appropriateness for the nature of the event.

### Example 3

The same user as in Example 2 with occasional angina pectoris episodes drives in a suburban neighborhood and experiences upcoming chest pain. She realizes she has forgotten her medication. However, in this case she does not enter a request for medication, but reports the chest pain. In this case the device recognizes the key phrase “Upcoming Chest Pain”, but has no reference to a personal physician or medical history. In this case the device may provide contact information to two cardiac emergency clinics, sorted by proximity.

### Level 4

Information of Box 101, Box 102, Box 103 and Box 104 is entered into the sorting algorithm.

An exemplary embodiment according to the invention comprises

a database with contact information for contactable entities, including location information, entered by or on behalf of a user,
a location determination capability,
a search capability for information about locally available contactable entities, including information about location and nature of the contactable entity,
a capability to collect data with respect to the nature of the event,
a keyword recognition capability to match the nature of the event to the nature of the contactable entity and determine the appropriateness of the contactable entity for the event.
a contact decision algorithm including:
   a. a capability to determine proximity between an event and contactable entities,
   b. a capability to assess the nature of the event, and
   c. a sorting capability based on proximity and on appropriateness of contactable entities for the nature of the event.

Activation of the Device Triggers
a contact information input into the algorithm,
a determination of the location,
a location input to the algorithm,
generation of information for locally available contactable entities, including information about location and nature by the search capability of the device,
a keyword matching sequence to determine the appropriateness of the contactable entity,
an input of information for locally available contactable entities into the algorithm
data collection to assess the nature of the event, and
an input of data with respect to the nature of the device into the algorithm.
   The algorithm sorts the contactable entities entered by or on behalf of the user and the contactable entities entered by the search capability of the device by proximity to the event and by appropriateness for the nature of the event, and produces a list of contactable entities prioritized by proximity and by appropriateness for the nature of the event.
   Examples of level 4 will be disclosed further below in Examples 10 and 11.

### Level 5

Information of Box 101, Box 102, Box 103, Box 104 and Box 107 is entered into the sorting algorithm.
An exemplary embodiment according to the invention comprises
a database with contact information for contactable entities, including location information, entered by or on behalf of a user,
a location determination capability,
a search capability for information about locally available contactable entities, including information about location and nature of the contactable entity,
a capability to collect data with respect to the nature of the event,
a keyword recognition capability to match the nature of the event to the nature of the contactable entity and determine the appropriateness of the contactable entity for the event.
an Internet search capability for information relevant to the event.
a contact decision algorithm including:
   a. a capability to determine proximity between an event and contactable entities,
   b. a capability to assess the nature of the event,
   c. a capability to assess the nature of the invent based on Internet input, and
   d. a sorting capability based on proximity and on appropriateness of contactable entities for the nature of the event.

### Activation of the Device Triggers

1. a contact information input into the algorithm,
2. a determination of the location,
3. a location input to the algorithm,
4. generation of information for locally available contactable entities, including information about location and nature by the search capability of the device,
5. a keyword matching sequence to determine the appropriateness of the contactable entity,
6. an input of information for locally available contactable entities into the algorithm
7. data collection to assess the nature of the event, and
8. an input of data with respect to the nature of the device into the algorithm.
   The algorithm sorts the contactable entities entered by or on behalf of the user and the contactable entities entered by the search capability of the device by proximity to the event and by appropriateness for the nature of the event, and produces a list of contactable entities prioritized by proximity and by appropriateness for the nature of the event.
   Examples of level 5 will be disclosed further below, in Examples 12 and 13.

In some embodiments the user of the device may use the prioritized contact list to contact desired entities. In some embodiments the device may automatically contact or attempt to contact entities according to the prioritized contact list. In some embodiments of the invention a user may instruct the device to contact entities according to the prioritized contact list

In some embodiments a user may introduce instructions to the device to deviate from the contact list. For example, in some embodiments, the algorithm may be programmed to prioritize contacting a parent of a child wearing and activating the device, independent of the distance of that parent to the location of the emergency.

In some embodiments, the algorithm will generate a list of contact entities with multiple redundancies, in case certain entities on the list cannot be contacted in order of priority. In some embodiments, the algorithm may be programmed to receive inputs with regards to responses received from entities contacted, and to generate a “stop” signal to the device or to a user of the device in case sufficient response to the event has been generated.

### Example 4

For instance, a device may have previously entered contact information for a remotely located personal physician, and may have identified a local emergency physician as a back up. The local emergency physician may have a lower priority on the list of entities to be contacted. If a personal physician has been successfully notified, and the device detects that a phone connection between the physician and the user of the device has been established, the device may cancel a call to the local emergency physician.

Alternatively, if the personal physician cannot be contacted, but a successful contact with the local emergency physician has been established, the algorithm may cancel any repeat calls to the personal physician, if so programmed.

In some embodiments of the invention, assessing the nature of the event comprises assessing hazards associated with the event and performing a risk analysis, wherein the risk analysis in part determines the prioritization of the contactable entities on the contact list.

In some exemplary embodiments of a system according to the invention information may be entered into the device by touch buttons, and distinguish between 4 types of events, medical (M), Technical (T), Criminal Activity (C) and Accidental (A), as well as 3 levels of risk: Low (1), Medium (2) and High (3). Such assessment may be entered as simple combination codes, like M1 or C3. The following examples illustrate possible scenarios based on this system:

### Example 5

A person with a known heart condition in a major downtown area may experience a more than normal shortage of breath, but no chest pain or weakness. This person may activate the M1 level. In this case the algorithm may provide the number of a personal physician, an address of a nearby pharmacy for a possible medication refill, and a phone number of a close-by relative. In the case of more severe shortness of breath and M2 message may be sent, and the algorithm may automatically alert the personal physician and request an urgent call to the patient. Even more severe symptoms may trigger an M3 message, an automatic dispatch call to 911, and an automatic set of follow-up calls to other emergency responders in the area identified by the search capability of the device.

### Example 6

A person experiences an engine failure on a quiet suburban street in a relatively safe area during daytime. An T1 message may alert a local towing service, or a larger organization like AAA.

The same person experiencing an engine failure on a busy freeway bridge without shoulders to safely pull over may send an T3 alert, resulting a call to a bridge management organization, like a government agency such as Caltrans, a 911 call, a notification of a nearby Highway Patrol call center of a breakdown event, with the location information of the breakdown, potentially resulting in closing off a lane of the bridge and providing safe passage for a tow truck, and urgent notification of a nearby towing company. In this case an adequate response from a high priority contactable entity, for instance a state agency managing the bridge may be sufficient for the system to terminate contact attempts to entities with lower priority on the list.

In some embodiments the capability to collect data with respect to the nature of the event, and the capability to assess the nature of the event may extend beyond inputs from a user, and may be collected on-command or even autonomously by the device.

### Example 7

For instance, a person experiencing an engine failure may consider the area of breakdown safe, but not be aware of a high crime activity in the area and send out a T1 level message. An algorithm with an Internet link to area safety information may recognize the area as unsafe, may alert a user or may automatically upgrade the rating to a T2 and may send an emergency dispatch to a towing service, or, in potentially high danger areas, upgrade the message to T3, and notify police of the problem.

Similarly, a roadside breakdown may appear to be on a quiet road, but the driver may not be aware of very high traffic density in after-dark rush hour. An algorithm with Internet access to such information may upgrade the severity of the event accordingly.

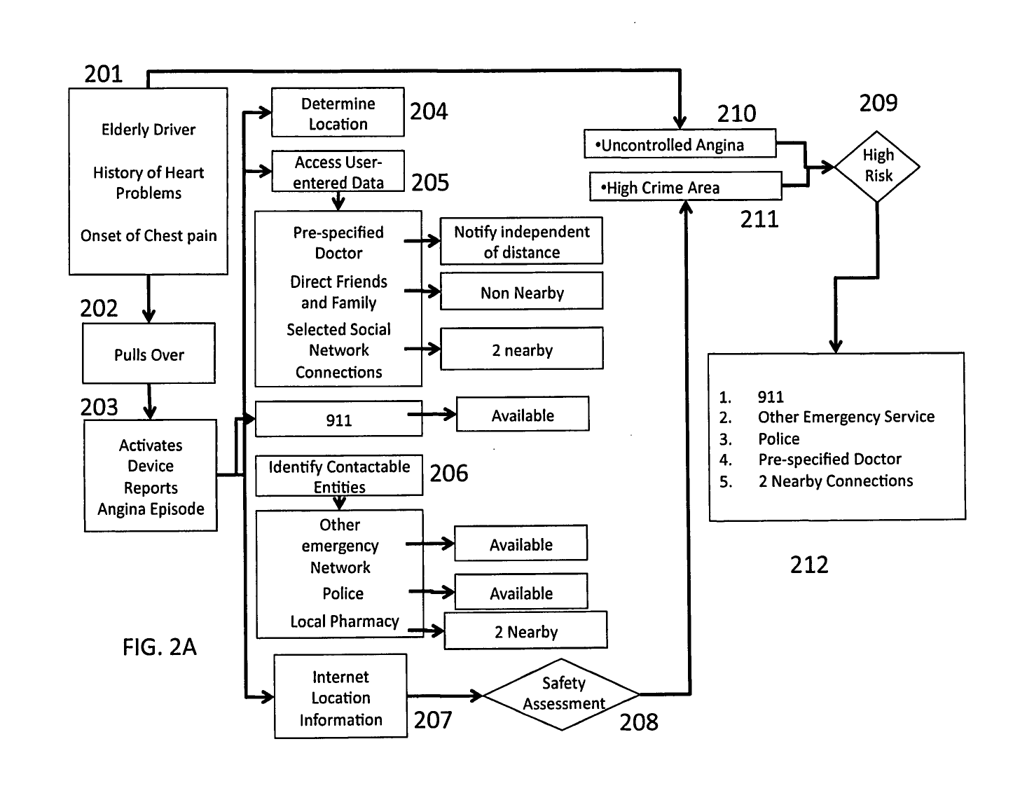

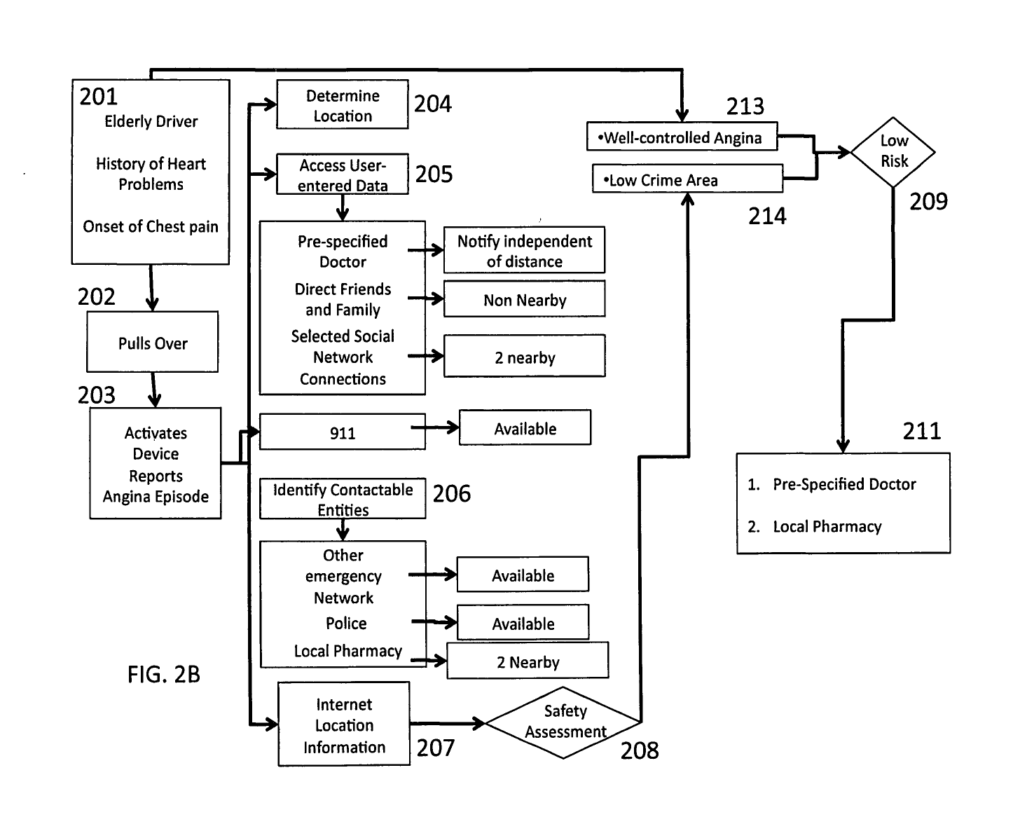

An exemplary embodiment of generation of two different prioritized contact lists based on risk analysis is further illustrated in Examples 8 and 9 in FIGS. 2 A and 2B.

Box 201 represents an elderly driver with a history of heart problems, who experiences on onset of chest pain. He pulls over (202), activates his device and enters “angina episode” (203).

FIGS. 2A and 2B illustrate a sequence of actions performed by the device.
Upon activation the device determines a location (204).
Next, the device accesses the user-entered data (205). The user-entered data comprise an instruction to call a pre-specified doctor, no nearby friends or family, and 2 Facebook contacts who have volunteered as emergency contacts.
The 911 emergency system is available.
Next, the device searches for other locally available contactable entities (206). Available are a private volunteer emergency network and a nearby police station. There are 2 pharmacies available within a specified distance.

The device also has a capability of accessing Internet location information (207), performing a safety assessment (208) and a capability of generating a risk analysis (209). The risk analysis may be a composite analysis based on driver information (201) and safety assessment (208.)

In FIG. 2A, Example 8, the device detects a dangerous history of angina pectoris episodes (210) in the patient's history of heart problems, and notices an Internet crime statistics chart that indicates a high crime rate in the area (211). The prioritized contact list (212) in this high risk scenario may include:

1. 911
2. Other emergency services

### 3. Police

4. Pre-specified personal physician
5. 2 nearby Facebook connections.

In FIG. 2B, Example 9, the device detects a history of mild angina (213), well-controlled with medication, and no specific safety concerns about the location (214). In this low risk scenario the contact list (215) may include
Pre-specified doctor
Address and driving directions to the local pharmacies for a possible medication refill, prioritized by travel time.

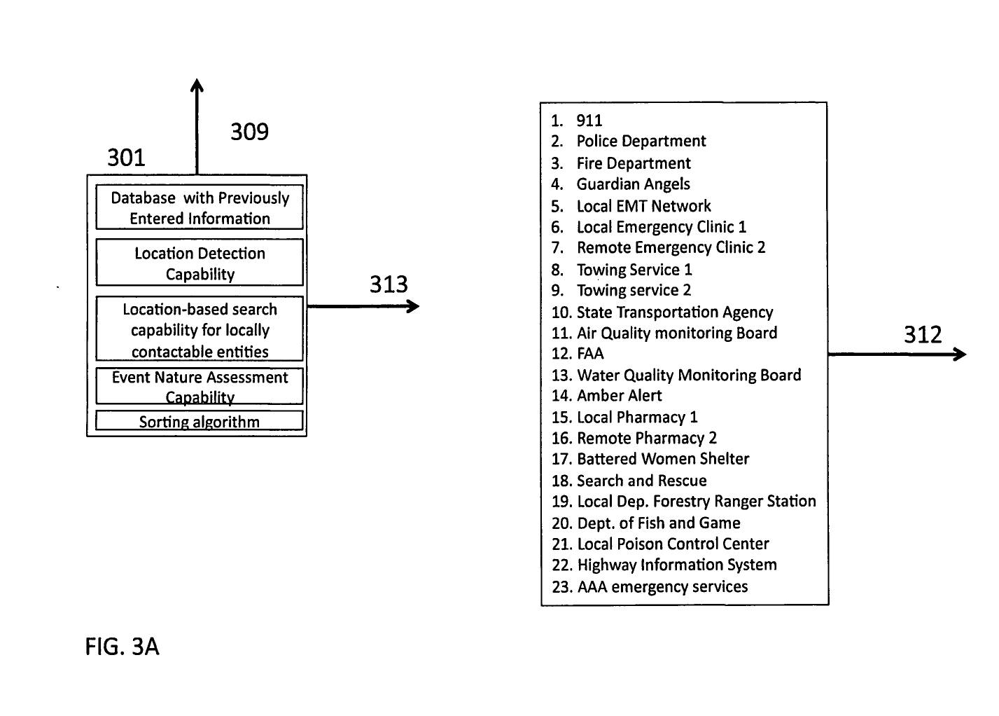

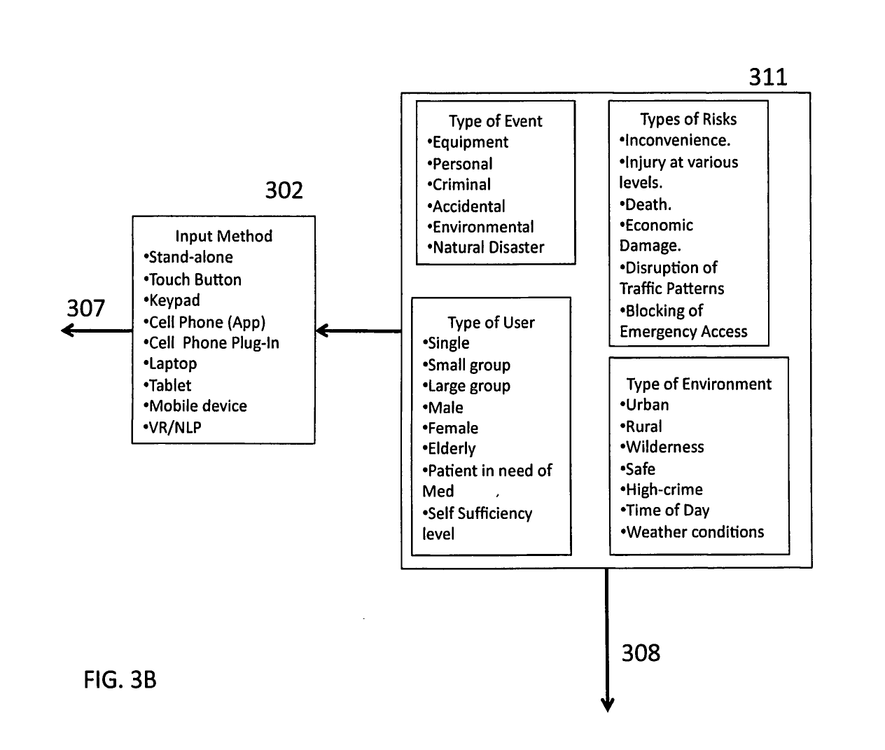

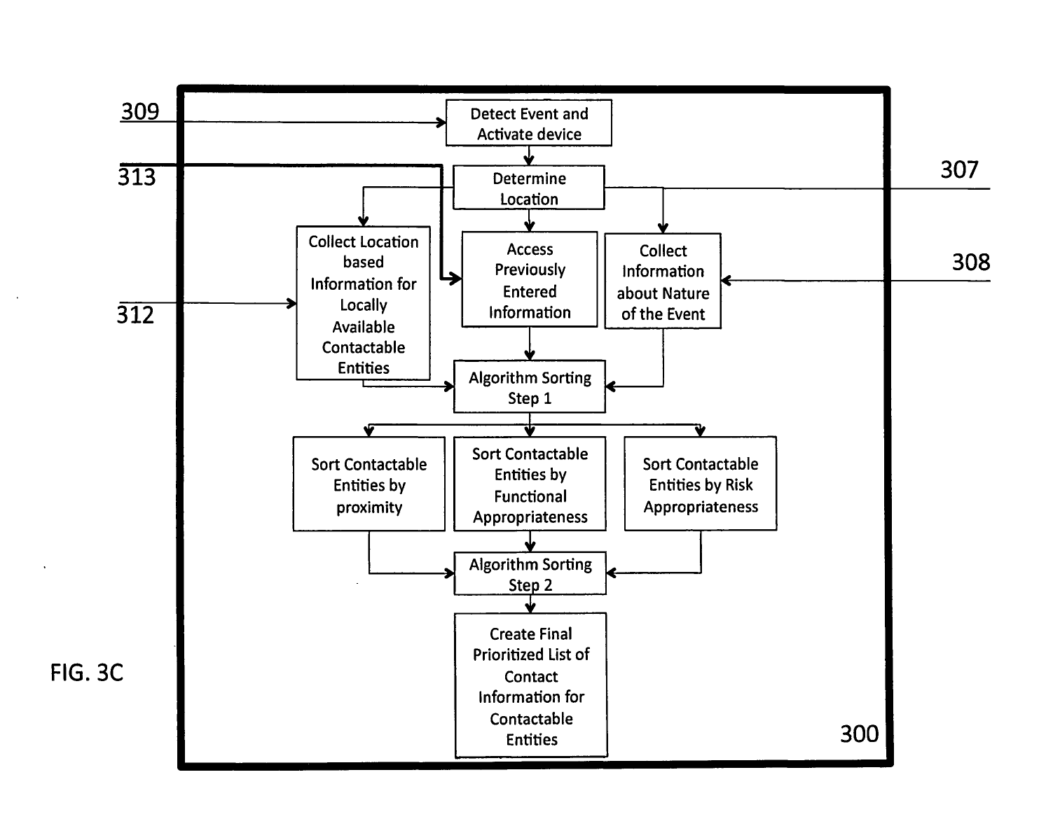

A more detailed description of exemplary embodiments of systems, devices and methods according to the invention is illustrated in the Flow Chart in FIG. 3A-3C

Box 300 in FIG. 3C represents a flow chart of events according to an exemplary embodiment of the invention.

Box 301 in FIG. 3A represents a device or system comprising functional components including a database with user-determined location based contact information, a location detection capability, a location based search capability for locally contactable entities, an assessment capability for the nature of a event and one or more sorting algorithms. Activities from Box 301 are entered into the flow chart of Box 300 according to arrow 309.

The device or system further comprises an interface function represented in Box 302 in FIG. 3B, enabling a user to enter event information represented in Box 311, including information with regards to the type of event (Box 303), the type of user (Box 304), the type of environment of the event (Box 305), and possible hazards at the location of the events, and risks associated with the hazards (Box 306). The information in Box 302 may be collected by the device according to arrow 307. Alternatively, the information about the nature of the event may be collected by the device in an automatic mode, as illustrated by arrow 308.

Flow Chart 300 illustrates an exemplary embodiment of a flow of actions according to the invention.

Upon occurrence of the event, the event may be detected and the device activated. The activation may be performed by a user of the device or system, or, in an automatic response mode, by the device itself. For instance, vital sign sensors may detect signs of a heart attack or dangerously low blood sugar, an accelerometer may detect a fall or a collision, a GPS mode may detect a hazardous area, etc.
Upon activation, the device activates a location detection system, and a location is determined. Determination of a location may be performed based on a variety of methods, such as GPS, cell phone tower vicinity, WIFI vicinity, geographical triangulation, etc.
Upon activation the device accesses the database with previously entered information in Box 301. This information may comprise contact- and location information of contactable entities, as well as other information previously entered by a user. The information is entered according to arrow 313

The search capability is activated, and searches available communication channels for information of locally available contactable parties represented in Box 310. The information may be collected from any locally available communication channel, including cellular networks, WIFI systems, wired systems phone lines, radio systems like HAM or CB etc. The information is entered as represented by arrow 312.

The device further collects information about the nature of the event, as received from the interface function 302 or in automatic mode indicated by arrow 308, including information about possible hazards and associated risks related to the event.

In some embodiments of systems according to the invention a user may enter information on some type of alphanumerical input device, such as a keyboard or touch screen. Systems according to the invention may be able to screen the input for key words and key phrases, such as “shortness of breath”, “fire” “refinery” “oil spill” “robbery” etc. In some embodiments the system may be equipped with a Natural Language Processing (NLP) capability, and be able to read, comprehend and interpret written text.

Some embodiments of systems according to the invention may be equipped with a Voice Recognition (VR) system combined with an NLP capability, and be able to comprehend and interpret spoken text. In some exemplary embodiments, the device or the system may be have a Voice Recognition (VR) capability, coupled with a Natural Language Processor (NLP) capability and an Artificial Intelligence (AI) unit.

In some embodiments automatic or semi-automatic means for data collection about the nature of the event may include the use of the audio and video capabilities. Some embodiments may include the use of sensors, such as thermometers, seismometers, anemometers, hygrometers, rain meters etc. to detect triggers like possible natural disasters, accelerometers for instance to measure a fall or collision, and sensors for indicators such as body temperature, heart rate, blood glucose, blood pressure and other signs or symptoms of adverse physiological events.

The capabilities for the assessment may be located on a device worn by a user, or on a remote device, where a device worn by the user serves as a communication interface.

In some embodiments the device may be a communication device in contact with a remote computer, for instance a user's home computer system. In the latter case, functional aspects of the invention may be performed by the remote computer, with the portable device being the pass-through communication device.

The nature of the event may be assessed by different factors, such as:

Types of event (Box 303), for example

a. Equipment failure, such as a flat tire or failing medical device.
b. Personal emergency, such as a fall, heart attack or a person wandering off.
c. Criminal activity, such as robbery, assault or burglary.
d. Accidents, such as car crash or a building collapse.
e. Environmental accidents, such as chemical spills.
f. Natural disasters, such as earthquakes or severe adverse weather.

Type of user (Box 304) involved in or at risk at the event, for example
i. Single, individual, small group, large group.
ii. Male, female.
iii. Juvenile, elderly.
iv. Patient in need of medication.
v. Persons with different levels of self-sufficiency.

Type of environment of the event (Box 305), for example
1. Urban. Suburban, rural, wilderness.
2. Safe, high-crime.
3. Time of day.
4. Weather conditions.
   ii. Types of risks as a consequence of the event (Box 306), for example
1. Inconvenience.
2. Injury at different levels.
3. Death.
4. Economic damage.
5. Disruption of traffic patterns.
6. Blocking of emergency access.

Hazard assessments and risk analysis may be important determinators for the urgency of a response. In some embodiments the device may be able to access hazard and risk information sources like police crime reports, neighborhood crime statistics, health alerts from Federal, Sate or local agencies, such as warnings about West Nile or Hanta viruses, red tides, shell fish poisoning, severe weather alerts, traffic alerts, traffic statistics, etc. In some embodiments of the invention the algorithm may combine multiple risk factors and assessments into multi-dimensional risk scoring functions.

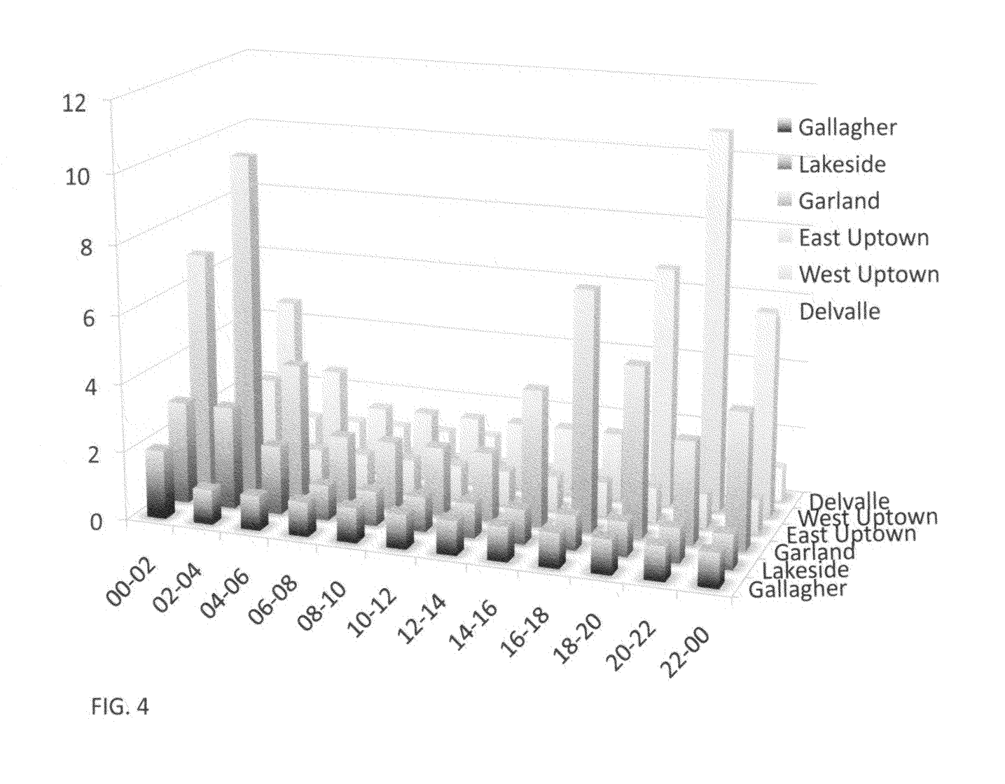

In the exemplary embodiment illustrated in FIG. 4, crime rates and associated risk levels are plotted as a function of geographical area and time of day. Certain neighborhoods in a city are known for high crime rates, with crime rates tapering off into adjacent neighborhoods. The y-axis shows two neighborhoods with peak crime rates. During the day crime rates in Garland typically peak around 2 am, with a minor secondary peak around 5 pm. In the West Uptown crime rates peak around 11 pm. The results can be represented as a bar graph or as a response surface.

The algorithm may be able to add additional dimensions to the risk scoring, for instance seasonal fluctuations in areas with large climatological differences between summer and winter, effects of race, gender and age on observed crime rates etc.

Other examples would be a composite risk analysis for a road side breakdown including the effects of location, time of day, weather, day of the week etc. or in the case of a medical emergency a composite risk analysis based on factors such as medical history of the victim, distance to a nearest treatment center, availability of emergency services and weather conditions.

Returning now to FIG. 3A-C, in a first sorting step in this exemplary embodiment the algorithm sorts contactable entities in multiple separate categories, For instance by proximity between a contactable entity and an event, by functional appropriateness for the nature of the event, and by risk appropriateness. The invention is not limited to the use of three sorting steps. For instance, some embodiments may treat the hazard assessment as one category together with the nature of the event and sort contactable entities in two separate categories. Some embodiments may comprise only one sorting step.

Functional appropriateness may be determined by a number of aspects of the event. For many types of events where some level of emergency is involved, 911 emergency response activation may be an appropriate first contact. However, the 911 system is frequently backed up or overloaded, and alternative responders may have to be alerted.

Examples of combinations of events and appropriate contactable entities include a fire and a fire department, a crime and a police department, a road side vehicle breakdown and a towing service, an accident at a refinery and an air quality and safety monitoring system, a kidnapping and an Amber alert system, an avalanche and a ski patrol organization, an attempted burglary and a neighborhood watch system, a chemical spill and a water quality monitoring system, etc.

Consideration of hazards and associated risk levels may be determined by a number of factors, including type of risk, such as inconvenience, possible levels of injury and risk of death, and level of self-sufficiency of a party involved in an event. For instance, a party at a remote location complaining about fainting and disorientation may be at risk of injury or death when trying to return from the location, and may need evacuation from the location. By contrast, a part complaining of abdominal discomfort and vomiting may be able to leave the location under its own control, and may only need to be provided with an information number for a (food) poison control center and the contact information and driving directions for a nearby emergency clinic.

In a second sorting step the algorithm synthesizes the information and priorities from the previous steps and produces a final prioritized list of contact information for contactable entities.

The examples below illustrate how small differences between 4 similar event scenarios and differences in search capabilities of the device may result in the generation of different prioritized lists of contactable entities. It should be understood that these examples are merely provided as illustrative exemplary embodiments, and that actual embodiments of decision making processes may be programmed to provide different contact orders.

### Example 10

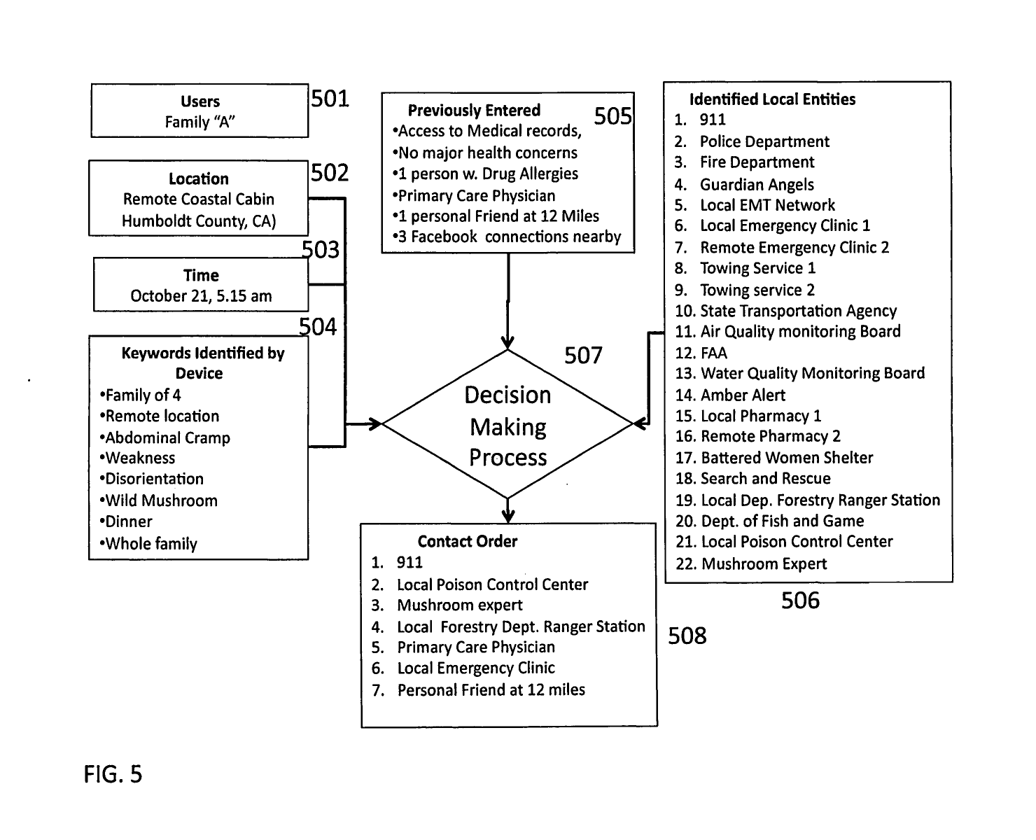

### FIG. 5

The users, family A (501) vacationing in a remote coastal cabin in Humboldt County in California experiences abdominal cramps and disorientation. They activate their device and enter an emergency message.

The device determines a location (502) and records date and time of day (503). The device also recognizes a number of keywords (504) in the emergency message

Family of 4

Remote location

Abdominal Cramp

Weakness

Disorientation

Wild Mushroom

Dinner

Whole family

The device accesses the previously entered information (505).

1. Access to medical records,
2. No major health concerns
3. 1 person w. Drug Allergies

### 4. Personal Physician

5. 1 personal Friend at 12 Miles
6. 3 Facebook connections nearby

The device also detects a large number of local entities (506) that may be contacted.

1. 911

### 2. Police Department

### 3. Fire Department

### 4. Guardian Angels

### 5. Local EMT Network

### 6. Local Emergency Clinic 1

### 7. Remote Emergency Clinic 2

### 8. Towing Service 1

9. Towing service 2

### 10. State Transportation Agency

11. Air Quality monitoring Board

### 12. FAA

### 13. Water Quality Monitoring Board

### 14. Amber Alert

### 15. Local Pharmacy 1

### 16. Remote Pharmacy 2

### 17. Battered Women Shelter

### 18. Search and Rescue

19. Local Dep. Forestry Ranger Station

### 20. Dept. of Fish and Game

### 21. Local Poison Control Center

### 22. Mushroom Expert

Based on the key phrases: “Abdominal Cramp, Weakness, Mushroom and Dinner” the algorithm goes through a decision making process 507 to select an emergency response related to mushroom poisoning, and based on location and the key phrase: “Disorientation” the algorithm selects an emergency response including 911 for sending a responder to the site.

Possible responders are further prioritized based on proximity.

The final prioritized responder list 508 looks as follows:

911

Local Poison Control Center

Mushroom expert

Local EMT network

Local Forestry Dept. Ranger Station

Personal Physician

Local Emergency Clinic

Personal Friend at 12 miles

### Example 11

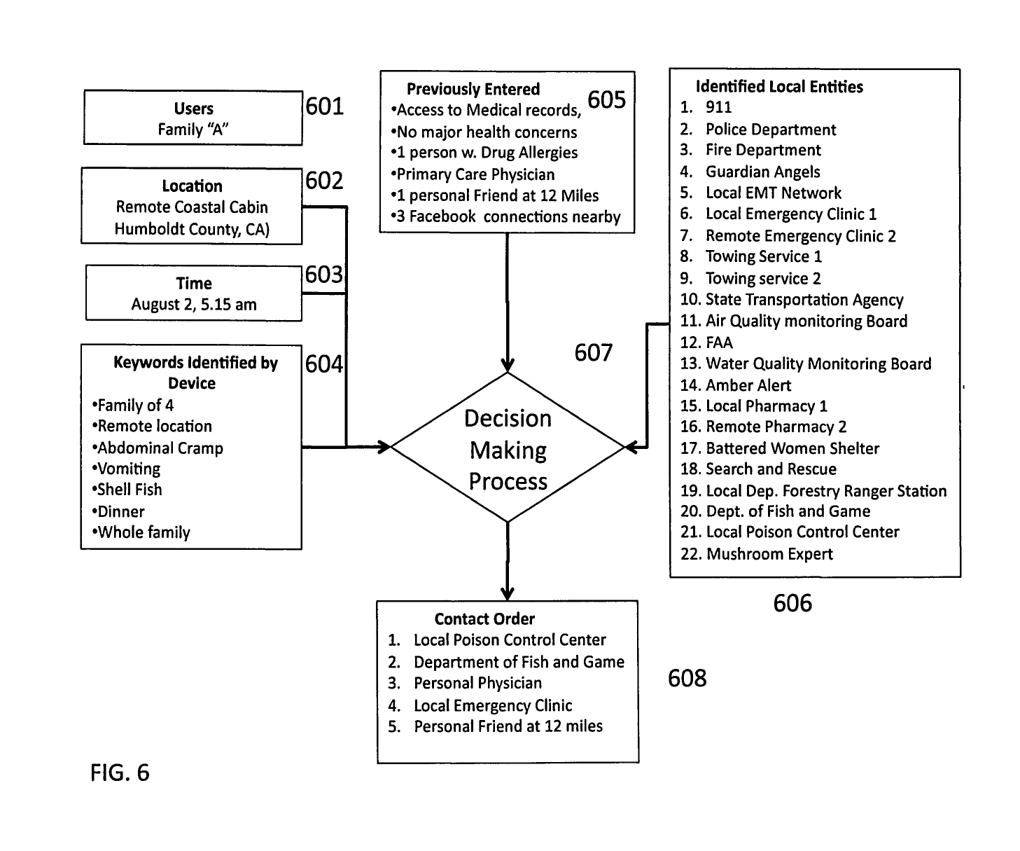

### FIG. 6

In a similar scenario a family vacationing in a remote coastal cabin in Humboldt County in California experiences abdominal cramps and vomiting.

The users, family A (601) vacationing in a remote coastal cabin in Humboldt County in California experiences abdominal cramps and vomiting.
They activate their device and enter an emergency message.
The device determines a location (602) and records date and time of day (603). The device also recognizes a number of keywords 604 in the emergency message

Family of 4

Remote location

Abdominal Cramp

Vomiting

Shell Fish

Dinner

Whole family

The device accesses the previously entered information (605).

1. Access to Medical records,
2. No major health concerns
3. 1 person w. Drug Allergies

### 4. Personal Physician

5. 1 personal Friend at 12 Miles
6. 3 Facebook connections nearby

The device also detects the same number of local entities (606) that may be contacted as the previous example.

In this example, based on the key phrases: “Abdominal Cramp, Vomiting, Shell Fish and Dinner” the algorithm goes through a decision making process (607) to select an emergency response related to shell fish poisoning. Information about a local poison control center and the Department of Fish and Game for information about possible shell fish warnings are provided. Since no signs of incapacity to drive are noted, no emergency responders are dispatched.

The final prioritized responder list (608) looks as follows:

Local Poison Control Center

Department of Fish and Game

Personal Physician

Local Emergency Clinic.

Personal Friend at 12 miles

### Example 12

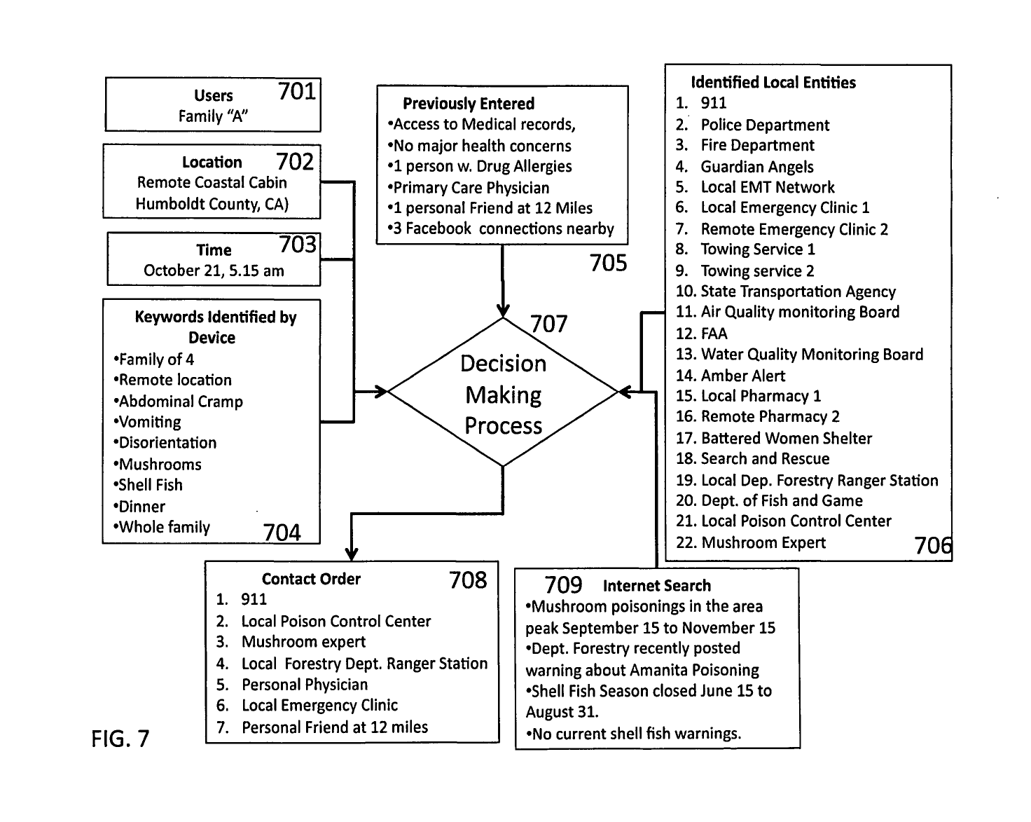

### FIG. 7

In this scenario, a family (701) vacationing in a remote coastal cabin in Humboldt County in California experiences abdominal cramps and disorientation after consuming both wild mushrooms and shellfish. The date is October 21.

In this scenario systems analogous to those in FIGS. 5 and 6 may not have been able to distinguish between mushroom poisoning and shell fish poisoning.

However, in this example, in addition to the functions described in Examples 7 and 8, the device has an intelligent search capability, that can access Internet information with information about the location, its environment and reported history.

The information entered into decision making protocol (707) includes the following keywords (704)

### 1. Family of 4

2. Remote location

### 3. Abdominal Cramp

### 4. Vomiting

### 5. Disorientation

### 6. Mushrooms

### 7. Shell Fish

### 8. Dinner

9. Whole family

In this example, an Internet Search capability (709), on the device collects information about the location, its environment and history. The device determines that the location is known for a history of mushroom poisonings peaking in the period of September 15 to November 15, and finds a recently posted warning of the Department of Forestry about Amanita poisonings in the area. The device also detects a closed shellfish season from June 15 to August 31, but no other shellfish warnings. The device notices the date of October 21.

Based on the provided information the device prioritizes the likelihood of mushroom poisoning over shellfish poisoning, and produces an prioritized list based on this estimate.

The final prioritized responder list looks as follows:

1. 911

### 2. Local Poison Control Center

3. Mushroom expert
4. Local Forestry Dept. Ranger Station

### 5. Personal Physician

### 6. Local Emergency Clinic

7. Personal Friend at 12 miles

### Example 13

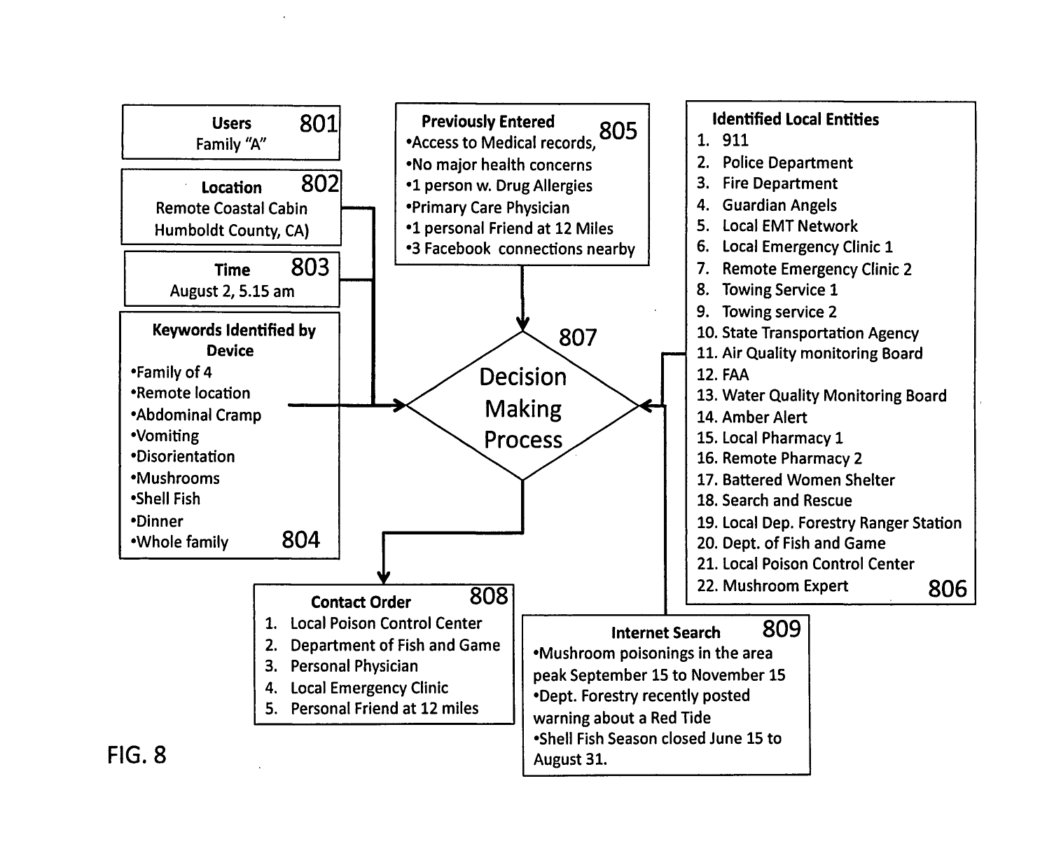

### FIG. 8

In this scenario, a family (801) vacationing in a remote coastal cabin in Humboldt County in California experiences abdominal cramps and disorientation after consuming both wild mushrooms and shellfish.

In this case, the date is August 2.

The information entered into decision making protocol (807) includes the following keywords (804), identical to the keywords in the previous example 9.

### 1. Family of 4

2. Remote location

### 3. Abdominal Cramp

### 4. Vomiting

### 5. Disorientation

### 6. Mushrooms

### 7. Shell Fish

### 8. Dinner

9. Whole family

In this example, an Internet Search capability (809), on the device collects information about the location, its environment and history. The device determines that the location is known for a history of mushroom poisonings peaking in the period of September 15 to November 15, but no current warnings about mushroom poisonings. The device also detects a closed shellfish season from June 15 to August 31. The device notices the date of August 2. The device also detects a recently posted warning of the Department of Fish and Game about a red tide in the area.

Based on the provided information decision making process (807) prioritizes the likelihood of shell fish poisoning over mushroom poisoning, and produces an prioritized list based on this estimate

The final prioritized responder list looks as follows:

Local Poison Control Center

Department of Fish and Game

Personal Physician

Local Emergency Clinic

Personal Friend at 12 miles

Some embodiments of the invention may be capable of managing the response to an event. Managing of the response may be performed by a user of the device, by the device in an automatic mode, by a contacted entity or responder, or by any other suitable party with access to the device.

Some aspects of managing the response to an event may include monitoring developments with respect to the event, changing priorities on the contact list in response to the developments, assessing the adequacy of a response, and terminating further attempts to contact contactable entities once an adequate response has been achieved.

In some embodiments the device may be capable of autonomously monitoring and managing a response, for instance in cases where a user has become incapacitated to control the device, like in the case of medical emergencies, or crimes like assault and kidnapping. In such cases a device may be in silent mode, so as not to alert a perpetrator of a crime, and send communications to a remote coordinator on a continuous basis, or, if desired, on an interval basis to conserve energy. In some embodiments the remote coordinator may be able to take control of the device.

Some embodiments of the invention may have a capability of recording real time audio and video capture of an event, which may assist contacted entities with the management of a response, as well as provide support for later follow-up to the event, for instance as forensic evidence.

The system may collect information on the user and user environment immediately upon an adverse event occurrence. This data may be communicated immediately and/or stored to allow retrieval of information by responders. The information collected may be used by both the system and responders in order to best assess the adverse event, the network of responders best suited, and determine next steps. The system may allow a user to send notification and initiate action to address an adverse event occurrence without the need for human interaction, delay, and/or clarification.

Reasons for changing priorities based on developments with respect to the event may include changes in the location of the event, as well as changes in the nature of the event. Changes in the location of the event may involve persons affected by an event changing location.

For instance, a wounded person driving a car may be trying to reach an emergency clinic on top of the priority list, but maybe confused and not follow the directions provided by a device according to the invention. If the person accidentally strays from the advised route, the device may detect the change in location, identify an alternative emergency clinic lower on the priority list, may change the priority on the list of available emergency clinics, and redirect the wounded person to the now most nearby clinic.

For instance, in the case of a kidnapping, the kidnapper may be changing locations rapidly. The victim may be wearing a secretly activated device, unbeknownst to the kidnapper. The device may detect the changing location of the victim, and change the priority of contacting law enforcement units appropriate for the changing location.

For instance, if the event is a natural disaster, like a forest fire or a tornado, a primary safe escape route may be prioritized to a user by a device, based on information of a likely path of the disaster provided by an organization like the National Weather Service. Changes to the forecast path of the disaster may prompt the device to prioritize another escape.

Changes in the nature of the event may include such examples as a deteriorating medical condition of a user of a device, a change in a forecast of adverse weather conditions, or a threat of violence escalating into actual violence.

For instance, the device may comprise a sensor for vital functions, such as heart rate, blood pressure, body temperature, respiratory rates, blood glucose levels etc. A driver with diabetes may receive an alert of dropping blood glucose levels, be advised to consume a glucose supplement, and be given directions to a nearby pharmacy or supermarket. Signs of further dropping of glucose levels, and an absence of signs to procure glucose supplements may trigger an elevated alarm like an audio alarm in the car. Further deterioration of the situation, such as clinically dangerously low glucose levels, erratic driving and sign like rapid heart beat may result in an alert to an emergency responder entity like 911, including information about the location and condition of the driver.

Such changes in response to the severity of the event may be combined with changes in response caused by the driver changing location.

Assessing sufficiency of a response may include assessments based on input of a user or a responder, on input from the device in an automatic mode or on a combination of inputs.

For instance, a user of a device may observe emergency responders arriving. Alternatively, the user herself may be approaching an emergency response facility, like an emergency room. In both cases an assessment of adequate response by a user may be entered to terminate further action by the device.

In some cases responders may reach a user of a device and instruct the device to terminate further actions.

In some cases, a device may autonomously take actions to terminate further activities with respect to an event. For instance, based on location, a device may determine that a user has reached an emergency clinic, and terminate further action autonomously. Alternatively, a device may send an alert to a user upon reaching a facility, and request possible termination of further action.

In some cases a device may detect emergency responders approaching, for instance through an audio function detecting a siren, and request termination of further actions by a user. Alternatively, the device, in automatic mode, may communicate the observation of approaching sirens to a contacted entity, such as a dispatcher for the responders approaching the event. In some embodiments a contacted entity, such as the dispatcher, may be able to communicate back to the device, and, if appropriate, terminate further action.

Some aspects of managing the response to an event may include improving communications between responders to an event.

In some embodiments the device may provide responders with the prioritized list of contactable entities, and with a list of entities that have been successfully contacted. In some embodiments the device may become a communication hub between responders, for instance by automatically hosting a conference call.

For instance, once contacts with a 911 call center and a personal physician have been established, the device may be prompted to host a conference call between the user of the device at the event, the 911 dispatcher and the physician.

Some embodiments of the invention may include systems capable of establishing user-responder networks with extended or customized capabilities for information exchange. Embodiments may not be limited by geographical location. For instance, a user-responder network may be a country-wide network. A device, worn by a user, may prioritize members of the network over other contactable entities when generating a prioritized contact list.

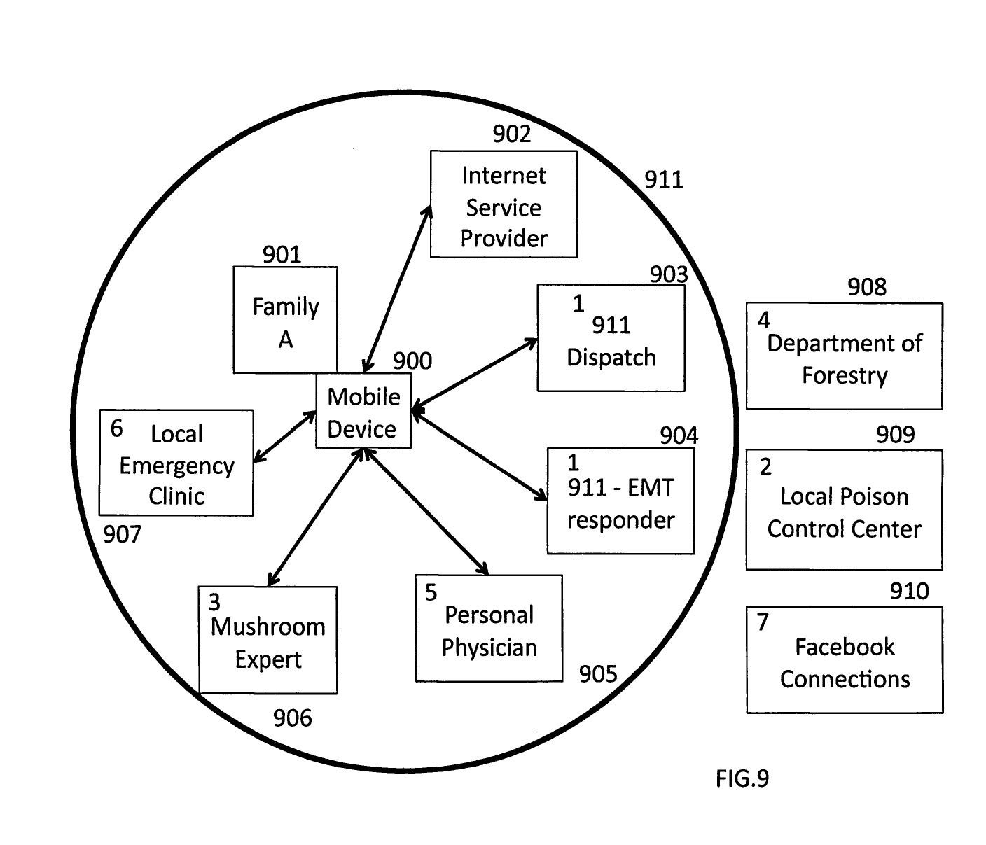

A non-limiting, illustrative example of a network 911 established by an embodiment of the invention is illustrated in FIG. 9. The example is based on the prioritized contact list of FIG. 5. At the center of the network is mobile device 900, for instance a smart phone operated by a user 901. Internet Service Provider 902 has provided the information to cell phone 900 to compile the prioritized contact list and enable the establishment of network 911. Attempts to make contact with contactable entities has been made in order of priority, and successful contacts have been established with 911 (903), mushroom expert 906, personal physician 905, who may be entirely remote from the location, and local emergency clinic 907. No contacts could be established with the Department of Forestry 908 and local poison control center 909. Based on the adequacy of the response, the algorithm in cell phone 900 has decided that contact with Facebook connections 910 was not required.

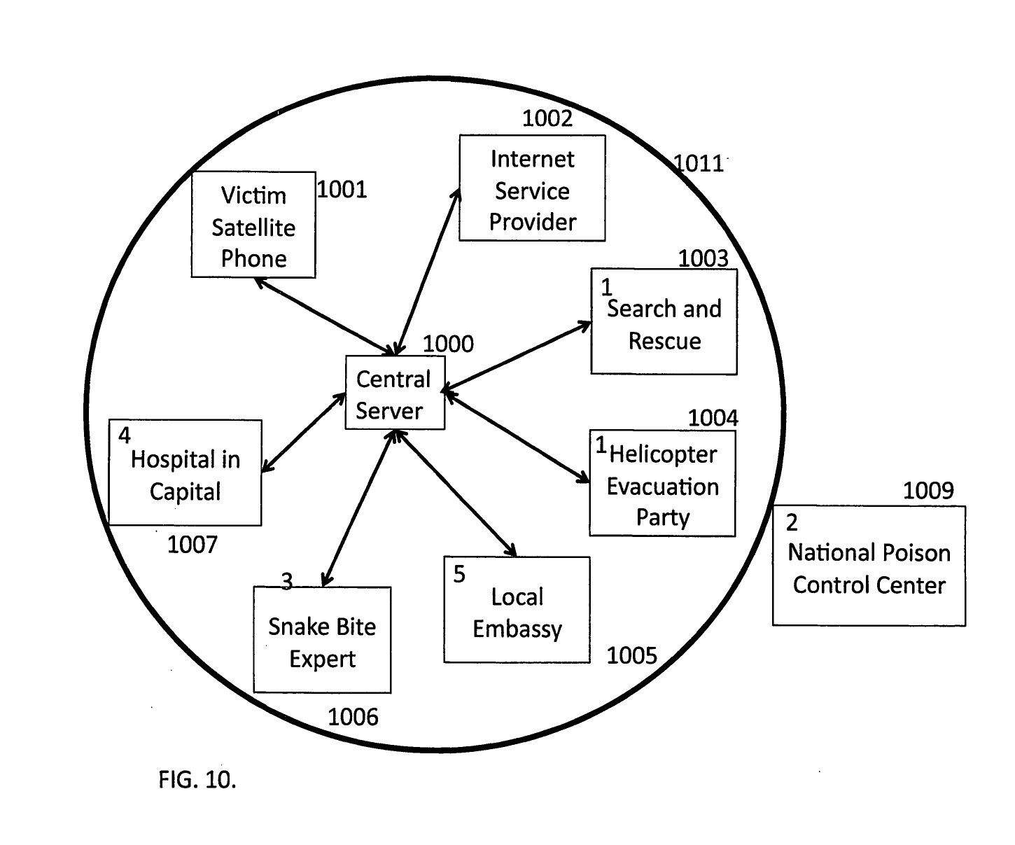

An alternative non-limiting, illustrative example of a network 1011 is illustrated in FIG. 10. In this example a user 1001 has signed up for a service providing a rescue program controlled by a central server 1000. The user is located on a remote location in a country with limited infrastructure and has been bitten by s venomous snake. User 1001 has activated server 1000 through a satellite phone. The service has pre-arranged contracts with a search and rescue company, specialized in helicopter evacuations. The service also has established contacts with the local embassy, and is aware of a hospital in the capital with a helicopter pad, not far from the embassy. The national poison control center could not be reached, but a snake bite expert with expertise of local venomous snakes has been contacted.

Some embodiments may include systems comprising devices worn by a user as well as devices worn by other entities, such as responders. The devices may include dedicated devices specifically designed for this purpose, or general purpose devices like cell phones, with installed custom mobile application.

The systems may be capable of transmitting and receiving enhanced levels of information, for instance private information from a user, such as medical records, or readings from sensors worn by a user, such as vital sign sensors.

In some embodiments such systems may be provided to users and responders as a one-time acquisition. In some embodiments such systems may be provided as a service package, for instance for a regularly recurring user fee.

As will be appreciated by one skilled in the art, the present invention may be embodied as a system, device, method or computer program product. Accordingly, the present invention may take the form of an entirely hardware embodiment, an entirely software embodiment (including firmware, resident software, micro-code, etc.) or an embodiment combining software and hardware aspects. Furthermore, the present invention may take the form of a computer program product embodied in any tangible medium of expression having computer readable program code embodied in the medium. Some embodiments of the invention comprise a non-transitory computer readable medium having instructions recorded thereon which, when executed by a processor, cause the processor to perform a method for managing communications with respect to an event.

Some embodiments of the invention are capable of determining geographic locations and of calculating proximities, expressed as distances or travel times. Some embodiments are capable of receiving such information from a companion device. The technologies for such capabilities are known in the art, are commercially available, and can be readily be adapted and incorporated in embodiments of the invention by those of ordinary skills in the art.

Some embodiments of the invention are capable of searching communication channels, such as WiFi networks or cellular phone networks, of accessing and searching the Internet and of performing keyword searches and of prioritizing identified keyword matches. The technologies for such capabilities are known in the art, are commercially available, and can be readily adapted and incorporated in embodiments of the invention by those of ordinary skills in the art.

Some embodiments of the invention comprise natural language processing (NLP) capabilities to process and interpret written text input from a user. Some embodiments of the invention comprise Voice Recognition (VR) capabilities, combined with NLP capabilities to recognize and interpret spoken text input from a user.

Some embodiments of the invention comprise machine learning (ML) or artificial intelligence (AI) capabilities and are able to improve their own performance as more information becomes available.

The technologies for NLP, VR, ML and AI are known in the art, are commercially available, and can be readily adapted and incorporated in embodiments of the invention by those of ordinary skills in the art.

Some embodiments of the invention may comprise mobile electronic communication devices, such as a GPS and Internet enabled cell phone (“Smart phone”) and all enabling functions of the invention may be performed using software comprised by cell phone.

Some embodiments may comprise stationary devices, such as home or office computers, servers, modems, routers etc. In some embodiments a mobile electronic communication device may act as an information pass-through communication device, and as a device to activate a system, while other enabling functions of the invention may be performed using stationary devices.

The examples and embodiments described above are strictly non-limiting examples and exemplary embodiments. They are included for the sole purpose of illustrating the invention, and are not to be interpreted as limitations on the entire scope of the invention as described in this disclosure.

We claim:

1. A method for managing communications with respect to an event, comprising the steps of
determining a location of the event,
providing information about a nature of the event,
using locally available electronic communication channels for identifying a number of contactable entities,
determining locations and nature of contactable entities,
determining proximities between contactable entities and the event,
determining appropriateness of contactable entities to the nature of the event,
providing a list of contactable entities, prioritized by proximity to the event and by appropriateness to the nature of the event.

2. The method of claim 1, further comprising the step of providing a limitation criterion for the number of contactable entities.

3. The method of claim 1, wherein the limitation criterion is based on proximity

4. The method of claim 1, wherein the limitation criterion is a pre-defined maximum for the number of contactable entities.

5. The method of claim 1, wherein the appropriateness of contactable entities is based on a keyword match between the information about the nature of the event and the nature of the contactable entity.

6. The method of claim 1, further comprising the steps of
accessing an information database with previously entered contactable entities,
determining proximities between contactable entities in the database and the event, and
determining appropriateness of contactable entities in the database to the nature of the event.

7. The method of claim 1, further comprising the steps of
performing an Internet-based search based on location of the event and information about the nature of the event, and
using results of the Internet-based search in prioritizing contactable entities.

8. The method of claim 1, further comprising the steps of
performing a risk analysis and
using results of the risk analysis in prioritizing contactable entities.

9. The method of claim 1, further comprising the steps of
monitoring developments with respect to the event, and
updating the list of contactable entities, prioritized by proximity to the event and by appropriateness to the nature of the event, based on the developments with respect to the event.

10. A non-transitory computer readable medium having instructions recorded thereon which, when executed by a processor, cause the processor to perform a method for managing communications with respect to an event, comprising the steps of
determining a location of the event,
providing information about a nature of the event,
using locally available electronic communication channels for identifying a number of contactable entities,
determining locations and nature of contactable entities,
determining proximities between contactable entities and the event,
determining appropriateness of contactable entities to the nature of the event,
providing a list of contactable entities, prioritized by proximity to the event and by appropriateness to the nature of the event.

11. The non-transitory computer readable medium of claim 10, wherein the method further comprises the step of providing a limitation criterion for the number of contactable entities.

12. The non-transitory computer readable medium of claim 10, wherein the limitation criterion is based on proximity

13. The non-transitory computer readable medium of claim 10, wherein the limitation criterion is a pre-defined maximum for the number of contactable entities.

14. The non-transitory computer readable medium of claim 10, wherein the appropriateness of contactable entities is based on a keyword match between the information about the nature of the event and the nature of the contactable entity.

15. The non-transitory computer readable medium of claim 10, wherein the method further comprises the steps of
accessing an information database with previously entered contactable entities,
determining proximities between contactable entities in the database and the event, and
determining appropriateness of contactable entities in the database to the nature of the event.

16. The non-transitory computer readable medium of claim 10, wherein the method further comprises the steps of the steps of
performing an Internet-based search based on location of the event and information about the nature of the event, and
using results of the Internet-based search in prioritizing contactable entities.

17. The non-transitory computer readable medium of claim 10, wherein the method further comprises the steps of the steps of
performing a risk analysis and
using results of the risk analysis in prioritizing contactable entities.

18. The non-transitory computer readable medium of claim 10, wherein the method further comprises the steps of
monitoring developments with respect to the event, and
updating the list of contactable entities, prioritized by proximity to the event and by appropriateness to the nature of the event, based on the developments with respect to the event.

19. A system for managing communications with respect to an event, comprising
a mobile electronic communication device,
a location determination capability
an electronic search capability for contactable entities
a user input interface
a keyword matching capability
a proximity calculation capability
a sorting algorithm based on proximity and keyword match
an output interface, and, optionally
an information database with previously entered contactable entities and, optionally, an Internet-based search capability,
wherein the algorithm comprises instructions for receiving input from
the location determination capability,
the electronic search capability for contactable entities,
the user input interface,
the keyword matching capability,
the proximity calculation capability, and, optionally,
the information database with previously entered contactable entities and, optionally,
the Internet-based search capability, and wherein
the algorithm comprises instructions for providing output to the output interface comprising a list of contactable entities, prioritized by proximity to the event and by appropriateness to the nature of the event.

20. The system of claim 17, further comprising
a capability to monitor developments with respect to the event, and wherein
the algorithm comprises instructions for receiving input the capability to monitor developments with respect to the event, and wherein
the algorithm comprises instructions for providing output comprising updates to the list of contactable entities, prioritized by proximity to the event and by appropriateness to the nature of the event, based on the developments with respect to the event.
